(19) United States
(12) Patent Application Publication
(10) Pub. No.: US 2010/0299725 A1
(43) Pub. Date: Nov. 25, 2010

(54) WIRELESS LAN ACCESS POINT DEVICE AND UNAUTHORIZED MANAGEMENT FRAME DETECTION METHOD

(75) Inventor: Daisuke YAMADA, Nagoya (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/785,098

(22) Filed: May 21, 2010

(30) Foreign Application Priority Data
May 22, 2009 (JP) 2009-124316

(51) Int. Cl. G06F 21/00

(52) U.S. Cl. 726/4

(57) ABSTRACT

A wireless LAN access point device is structured to perform frame-based data transmission and reception to and from a wireless terminal over a wireless communication path. The wireless LAN access point device has a communication module configured to transmit and receive a frame to and from the wireless terminal. In the wireless LAN access point device, when the communication module receives a predetermined management frame from the wireless terminal, an execution module performs a corresponding operation specified by the received management frame. In the wireless LAN access point device, when the communication module receives a frame, a sequence monitor module obtains a sequence number included in the frame. In the wireless LAN access point device, when a first sequence number obtained by the sequence monitor module and a second sequence number included in the received management frame satisfy a preset condition, an unauthorized frame judgment module identifies the received management frame as an unauthorized frame. This arrangement has the high versatility and effectively protects a wireless LAN network from unauthorized accesses.

### CROSS-REFERENCE TO RELATED APPLICATION

The present application claims priority from Japanese application P2009-124316A filed on May 22, 2009, the content of which is hereby incorporated by reference into this application.

### BACKGROUND

1. Field of the Invention

The present invention relates to a wireless LAN access point device structured to perform frame-based data transmission and reception to and from a wireless terminal over a wireless communication path

2. Description of the Related Art

Wireless LAN devices in conformity with the IEEE802.11 protocol have been widely used. Such a wireless LAN device sends and receives packets called management frames to control information, such as a connection status. The management frames are generally sent and received without encryption and electronic signatures. This is one major cause of an unauthorized access to a wireless LAN network. Namely the use of the management frames causes a security issue.

One typical example of the unauthorized access is ‘spoofing’ or impersonation by a third person. For example, an unauthorized wireless LAN terminal operated by a third person who intends to make an unauthorized access spoofs as an authenticated wireless LAN terminal with the access right and sends a deauthentication frame to an authorized access point. The authorized access point then deauthenticates and disconnects the authenticated wireless LAN terminal. The authenticated wireless LAN terminal under disconnection sends an authentication frame again. An unauthorized access point provided by the third person receives the authentication frame and establishes connection with the authenticated wireless LAN terminal. There is accordingly possibility that information is leaked from the authenticated wireless LAN terminal.

As a measure against such a spoofing attack, a technique of adding an electronic signature to each management frame to enhance the security level has been developed and standardized (IEEE802.11TGw). The existing wireless LAN devices designed before the widespread of this new protocol, however, still have the security problem. This measure does not allow for the combinational use of wireless LAN devices of the old protocol with wireless LAN devices of the new protocol. Namely all the existing wireless LAN devices of the old protocol should be replaced with wireless LAN devices of the new protocol. This leads to the issues of the high cost and the low resource saving effect. The prior art techniques in this field are described in, for example, Japanese Patent Laid-Open No. 2007-089006, No. 2008-072402, and No. 2006-279438.

### SUMMARY

In order to solve at least part of the problem of the related art discussed above, there would be a requirement for providing a versatile method of effectively protecting a wireless LAN network from unauthorized accesses.

The present invention accomplishes at least part of the requirement mentioned above and the other relevant requirements by any of various aspects and applications discussed below.

### 1. First Example of Application

According to a first example of application of the present invention, there is provided a wireless LAN access point device for transmitting data frames to and receiving data frames from, a wireless terminal over a wireless communication path, comprising

a communication module for transmitting data frames to and receiving data frames from, the wireless terminal;

an execution module for executing a specific process in response to a predetermined management frame received by the communication module from the wireless terminal;

a sequence monitor module for obtaining a sequence number included in the data frame each time the communication module receives the data frame; and

an unauthorized frame judgment module for identifying the received management frame as an unauthorized frame when a first sequence number obtained by the sequence monitor module and a second sequence number included in the received management frame satisfy a preset condition.

Whenever the wireless LAN access point device having such a configuration as described above receives a frame, it obtains a sequence number included in the frame, and when it receives a management frame from the wireless terminal, it checks whether the received management frame is an unauthorized frame, based on the sequence number obtained by the sequence monitor module and the sequence number included in the received management frame. Accordingly, this wireless LAN access point device securely detects an unauthorized management frame and enables various effective measures to be taken against such a spoofing attack. Further, since it detects an unauthorized frame based on the sequence numbers, its structure can be simplified. Also, since an unauthorized frame is detected on the side of the wireless LAN access point device on the basis of the sequence number, the wireless LAN access point device can be used with any wireless terminals built in compliance with any standard if they can send frames with sequence numbers. Thus, the wireless LAN access point device has high versatility, high resource-saving effect, and high cost-reducing effect. In effect, there is no special provision required on the side of the wireless terminal. Therefore, the wireless LAN access point device according to this example is applicable to the existing wireless terminals without any additional configuration, and also to the case where wireless terminals in compliance with the old and new standards coexist.

### 2. Second Example of Application

According to a second example of application of this invention, there is provided a wireless LAN access point device for transmitting data frames to and receiving data frames from, a wireless terminal over a wireless communication path, comprising:

a communication module for transmitting data frames to and receiving data frames from, the wireless terminal;

an execution module for executing a specific process in response to a predetermined management frame received by the communication module from the wireless terminal;

a sequence monitor module for obtaining a sequence number included in the data frame each time the communication module receives the data frame;

a signal strength monitor module for monitoring strength of a signal received when the frame is received, related to the information for identifying the terminal that has sent the frame; and

an unauthorized frame judgment module for judging the received management frame as an unauthorized frame in the case where the first sequence number obtained by the sequence monitor module and the second sequence number included in the received management frame satisfy a preset condition and/or the case where the change during a predetermined period in the signal strength monitored by the signal strength monitor module and related to the information for identifying the terminal that has sent the management frame, exceeds a preset range.

The wireless LAN access point device of this example of application can obtain the same result as the device of the first example of application. Also, since this wireless LAN access point device can detect the unauthorized frame by using the two methods based on the different viewpoints, the accuracy of detecting unauthorized frames and therefore security can be improved.

### 3. Third Example of Application

According to a third example of application of this invention, there is provided a wireless LAN access point device as defined in the first or second example of application described above, wherein the execution module prohibits the execution of the process related to the received management frame when the unauthorized frame judgment module judges the received management frame as an unauthorized frame.

Since the wireless LAN access point device having this configuration causes the execution module to prohibit the execution of the process related to the received management frame when the unauthorized frame judgment module judges the received management frame as an unauthorized frame, then the wireless LAN access point device can effectively protect itself against a spoofing attack.

### 4. Fourth Example of Application

According to a fourth example of application of this invention, there is provided a wireless LAN access point device as defined in any of the first through third examples of application described above, wherein the execution module includes an authentication module for performing an authentication process or a deauthentication process, essential for communication via the wireless LAN access point device; and the predetermined management frame includes a deauthentication frame that requests the deauthentication process.

Since the wireless LAN access point device having this configuration can detect an unauthorized deauthentication frame, various countermeasures can be devised against spoofing attacks using deauthentication frames.

### 5. Fifth Example of Application

According to a fifth example of application of this invention, there is provided a wireless LAN access point device as defined in any of the first through fourth examples of application above, wherein at least one of the preset conditions is that there is an overlap between the first sequence number already obtained and the second sequence number.

Since the sequence number is sequentially given to the frame as it is transmitted, there is no possibility that the same numbers are generated during almost the same period.

The wireless LAN access point device of this example assures highly accurate detection of unauthorized frames by taking advantage of such characteristics of the sequence numbers.

### 6. Sixth Example of Application

According to a sixth example of application of this invention, there is provided a wireless LAN access point device as defined in any of the first through fifth examples of application described above, wherein at least one of the preset conditions is that the difference between the second sequence number and one of the first sequence numbers already obtained which is closest to the second sequence number, exceeds a preset range.

Since the sequence numbers are continuously generated integers as the frames are transmitted, the difference between two consecutively received sequence numbers is not large even though the order of the received frames arriving from respective wireless terminals is changed, or some frames are missing. The wireless LAN access point device of this example, which uses this feature of sequence numbers, can detect unauthorized frames with high accuracy.

### 7. Seventh Example of Application

According to a seventh example of application of this invention, there is provided a wireless LAN access point device as defined in any of the first through sixth examples of application described above, wherein at least one of the preset conditions is that the communication module receives another frame which contains the same sequence number as the second sequence number within a preset period after the reception of the management frame.

The wireless LAN access point device of this example, which checks the overlap of sequence numbers even within a preset period after the reception of an unauthorized frame, can detect unauthorized frames with high accuracy by using the feature that the same sequence numbers are never generated within a certain period of time.

### 8. Eighth Example of Application

According to an eighth example of application of this invention, there is provided a wireless LAN access point device as defined in any of the first through seventh examples of application described above, further comprising a notification module for notifying a user of the wireless LAN access point device of a result of judgment resulted in when the unauthorized frame judgment module identifies the received management frame as an unauthorized frame.

The wireless LAN access point device of this example, which can notify the network administrator or the network users of the reception of unauthorized frames, can allow for a new measure, if necessary, against a third person using an unauthorized frame.

### 9. Ninth Example of Application

According to a ninth example of application of this invention, there is provided a wireless LAN access point device as defined in the eighth examples of application described above, wherein the notification module transmits mails indicating the result of judgment to a destination having predetermined address, as a means for notification.

With the wireless LAN access point device of this example, the network administrator or the network users can easily notice the reception of unauthorized frames.

### 10. Tenth Example of Application

According to a tenth example of application of this invention, there is provided a wireless LAN access point device as defined in the eighth or ninth example of application described above, wherein the notification module records the result of judgment as the operation history of the wireless LAN access point device in a memory device provided in the wireless LAN access point device, as the means for notification.

With the wireless LAN access point device of this example, the network administrator or the network users can easily notice the reception of unauthorized frames.

Further, this invention can be realized as a method for detecting unauthorized frames as will be described in an eleventh or a twelfth example of application as follows.

### 11. Eleventh Example of Application

According to an eleventh example of this invention, there is provided an unauthorized management frame detection method for use in a wireless LAN access point device for transmitting data frames to and receiving data frames from, a wireless terminal over a wireless communication path, the method detecting the unauthorized frame by receiving management frames from the wireless terminal and comprising the steps of:

obtaining a sequence number included in the frame each time the frame is received; and

detecting the received management frame as the unauthorized management frame if there is an overlap between the sequence number already obtained and the sequence number included in the received management frame, or if the difference between the sequence number included in the management frame and that one of the sequence numbers already obtained which is closest to the sequence number included in the management frame, exceeds a preset range.

### 12. Twelfth Example of Application

According to a twelfth example of application of this invention, there is provided an unauthorized management frame detection method for use in a wireless LAN access point device for transmitting data frames to and receiving data frames from, a wireless terminal over a wireless communication path, the method detecting the unauthorized frame by receiving management frames from the wireless terminal,

wherein if a frame including the same sequence number as that included in the received management frame is received within a preset period after the management frame has been received, then the received management frame is detected as the unauthorized management frame.

### 13. Thirteenth Example of Application

According to a thirteenth example of application of this invention, there is provided a wireless LAN access point device for transmitting data frames to and receiving data frames from, a wireless terminal over a wireless communication path, comprising:

a communication module for transmitting data frames to and receiving data frames from, the wireless terminal;

an execution module for executing a specific process in response to a predetermined management frame received by the communication module from the wireless terminal;

a signal strength monitor module for monitoring strength of a signal received when the frame is received, related to the information for identifying the terminal that has sent the frame; and

an unauthorized frame judgment module for judging the received management frame as an unauthorized frame in the case where a change during a predetermined period in the signal strength monitored by the signal strength monitor module and related to the information for identifying the terminal that has sent the management frame, exceeds a preset range.

Since the wireless LAN access point device according to this example monitors the received signal strength at each time of frame reception from the wireless terminal, and judges the received management frame as an unauthorized frame if the change during a predetermined period in the signal strength monitored by the signal strength monitor module, exceeds a preset range, various countermeasures against spoofing attacks can be devised through detecting unauthorized management frames. Also, since the wireless LAN access point device detects an unauthorized frame based on the received signal strength, the structure of the wireless LAN access point device can be simplified. Moreover, since the wireless LAN access point device of this example detects the unauthorized management frame on the basis of the received signal strength, it can be used with wireless terminals built in compliance with any standard whatever. This example accordingly has high versatility, high resource-saving effect, and high cost reducing effect. In effect, there is no special provision required on the side of the wireless terminal. Therefore, the wireless LAN access point device according to this example is applicable to the existing wireless terminals without any additional configuration, and also to the case where wireless terminals in compliance with the old and new standards coexist.

### 14. Fourteenth Example of Application

According to a fourteenth example of application of this invention, there is provided a wireless LAN access point device as defined in the thirteenth example of application as described above, wherein the execution module prohibits the execution of the process related to the received management frame when the unauthorized frame judgment module judges the received management frame as an unauthorized frame.

Since the wireless LAN access point device having this configuration causes the execution module to prohibit the execution of the process related to the received management frame when the unauthorized frame judgment module judges the received management frame as an unauthorized frame, then the wireless LAN access point device can effectively protect itself against a spoofing attack.

### 15. Fifteenth Example of Application

According to a fifteenth example of application of this invention, there is provided a wireless LAN access point device as defined in the thirteenth or fourteenth example of application described above, wherein the execution module includes an authentication module for performing an authentication process or a deauthentication process, essential for communication via the wireless LAN access point device; and

the predetermined management frame includes a deauthentication frame that requests the deauthentication process.

The wireless LAN access point device as defined in one of the thirteenth through fifteenth examples of application of the invention may be additionally provided with the configuration as defined in the wireless LAN access point device of the eighth, ninth or tenth example of application of the invention. Those composite arrangements also enjoy an advantage similar to that of the eighth, ninth or tenth example of application. This invention is not restricted in application to the wireless LAN access point devices or the unauthorized management frame detection methods discussed above but may be actualized as other applications such as, for example, an unauthorized management frame detection device, computer programs configured to attain the functionalities of the detection device and recording media with such computer programs recorded therein.

### BRIEF DESCRIPTION OF THE DRAWINGS

FIG. 1 is an explanatory diagram illustrating the configuration of a wireless LAN network WL using an access point 20 in a first embodiment according to the invention;

FIG. 2 is an explanatory diagram showing the schematic structure of the access point 20 in the first embodiment;

FIG. 3 is a flowchart showing an unauthorized frame detection process performed in the access point 20 of the first embodiment;

FIG. 4A is an explanatory diagram showing some cases of detection of an unauthorized frame in the unauthorized frame detection process of the first embodiment;

FIG. 4B is an explanatory diagram showing another case of detection of an unauthorized frame in the unauthorized frame detection process of the first embodiment;

FIG. 5 is an explanatory diagram showing the schematic structure of the access point 20 in a second embodiment according to the invention;

FIG. 6 is a flowchart showing an unauthorized frame detection process performed in the access point 20 of the second embodiment;

FIG. 7 is an explanatory diagram conceptually showing one status of monitoring received signal strength indication in the unauthorized frame detection process of the second embodiment;

FIG. 8 is an explanatory diagram showing the schematic structure of the access point 20 in a third embodiment according to the invention;

FIG. 9 is a flowchart showing an unauthorized frame detection process performed in the access point 20 of the third embodiment; and

FIG. 10 is a flowchart showing an unauthorized frame detection process performed in the access point 20 of a fourth embodiment according to the invention.

### DESCRIPTION OF THE PREFERRED EMBODIMENTS

Some modes of carrying out the invention are described below with reference to the accompanied drawings.

### A. First Embodiment

### A-1. Structure of Access Point 20

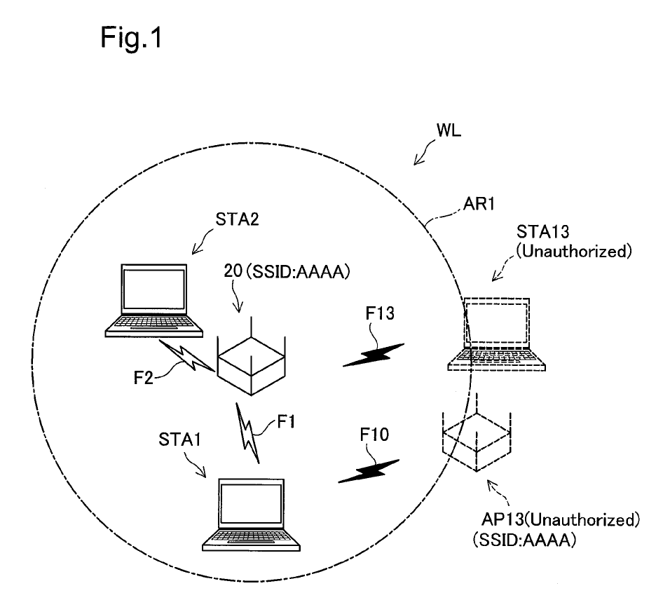

FIG. 1 illustrates the configuration of a wireless LAN network WL using an access point 20 in a first embodiment according to the invention. As illustrated, the wireless LAN network WL includes the access point 20 and terminals STA1 and STA2. The access point 20 is implemented by a relay unit for wireless LAN in conformity with the IEEE802.11 protocol. The terminals STA1 and STA2 are constructed to be capable of establishing MAC frame-based wireless communication in an infrastructure mode via the access point 20 in a wireless communication area AR1. The wireless communication area AR1 is specified as a restricted area for only specific people and may be set on company premises in this embodiment.

In this embodiment, each of the terminals STA1 and STA2 is implemented by a personal computer equipped with a wireless LAN adapter or a wireless LAN device for transmission and reception of radio waves to and from the access point 20. Each wireless LAN adapter has a unique MAC address assigned for identification thereof. The access point 20 has an SSID (service set identifier) assigned for identification thereof. In this embodiment, an SSID ‘AAAA’ is assigned to the access point 20.

The wireless LAN network WL may be subject to spoofing attacks by any unauthorized intruders on the company premises. According to one typical procedure of a spoofing attack, an unauthorized intruder brings in an unauthorized terminal STA13 and an unauthorized access point AP13 and illegally receives a management frame from the authorized access point 20 to obtain the SSID assigned to the access point 20. In the IEEE802.11 protocol, a beacon for giving basic information essential for wireless communication, an authentication frame requiring authentication for communication, and a deauthentication frame requiring deauthentication are defined as management frames.

While the authorized terminals STA1 and STA2 establish communication via the access point 20 by connections F1 and F2, the unauthorized intruder uses the unauthorized terminal STA13 and spoofs the MAC address of the terminal STA1 (specifically of its wireless LAN adapter) as a source address to send a deauthentication frame to the obtained SSID of the access point 20 by connection F13. The access point 20 then deauthorizes the terminal STA1 and terminates the connection.

The off-line terminal STA1 sends an authentication frame to the access point 20 for reconnection. The unauthorized access point AP13 set to have the same SSID ‘AAAA’ as the access point 20 may illegally receive the authentication frame and establish communication with the authorized terminal STA1 by connection F10. In such circumstances, there is a possibility that classified information and other important information are leaked from the terminal STA1 via the unauthorized access point A13. The access point 20 of this embodiment has a specific structure to prevent such information leakage by a spoofing attack as discussed below in detail.

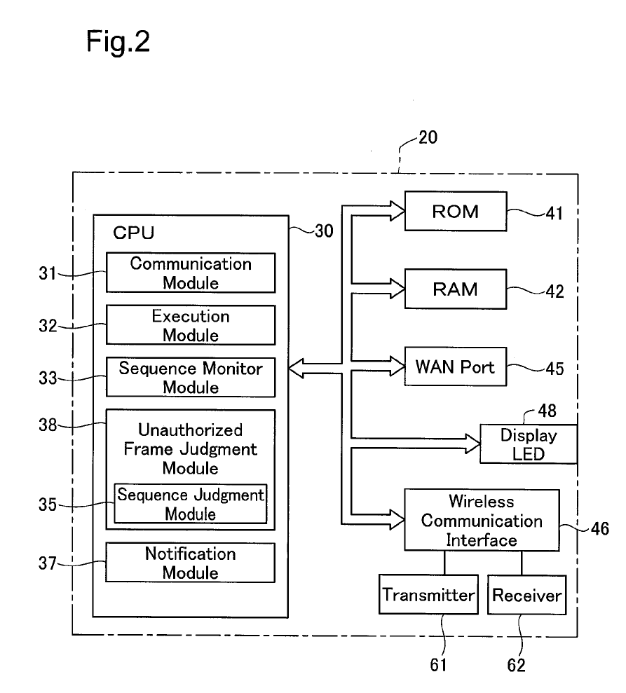

The structure of the access point 20 is schematically illustrated in FIG. 2. The access point 20 includes a CPU 30, a ROM 41, a RAM 42, a WAN port 45, a wireless communication interface 46, and a display LED 48, which are interconnected by a bus.

The CPU 30 loads a program stored in the ROM 41 onto the RAM 42 and executes the program to control the overall operations of the access point 20. The CPU 30 executes the program to function as a communication module 31, an execution module 32, a sequence monitor module 33, a unauthorized frame judgment module 38, and a notification module 37. In this embodiment, the unauthorized frame judgment module 38 includes a sequence judgment module 35 The details of these functional blocks will be discussed later.

The WAN port 45 works as an interface to access an external network, such as the Internet. The display LED 48 lights up or flashes to show the connection status and the communication status of the wireless LAN.

The wireless communication interface 46 is connected with a transmitter 61 for transmitting radio waves and with a receiver 62 for receiving radio waves. The transmitter 61 and the receiver 62 are built in the access point 20 to be capable of transmitting radio waves to the outside and receiving radio waves from the outside.

### A-2. Unauthorized Frame Detection Process

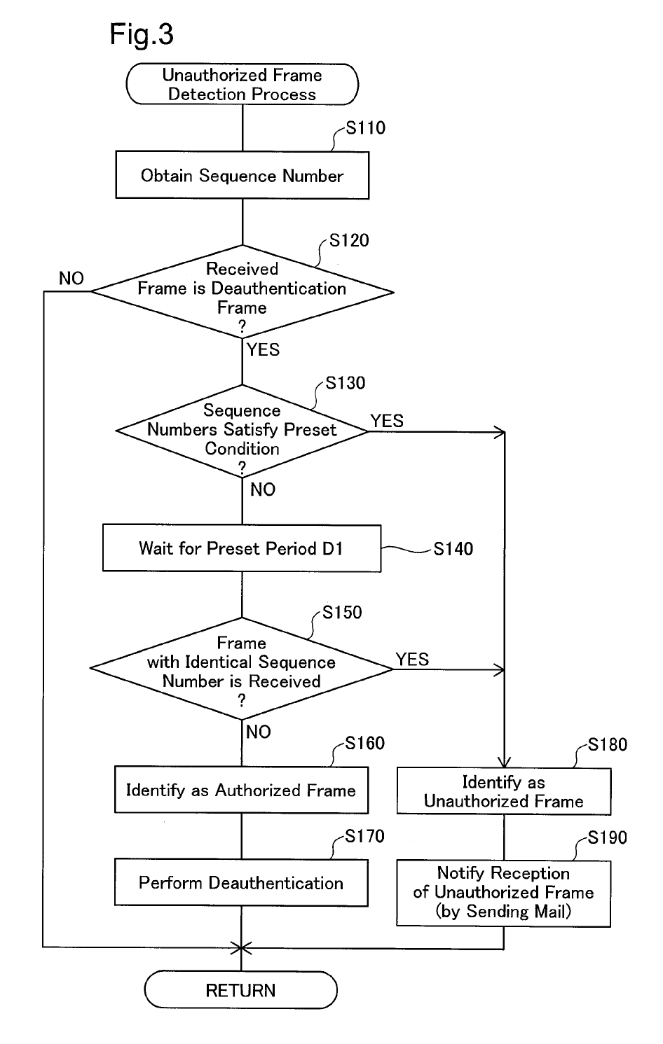

An unauthorized frame detection process performed in the access point 20 of the embodiment is described with reference to the flowchart of FIG. 3. The unauthorized frame detection process detects an unauthorized deauthentication frame (hereafter may simply be referred to as ‘unauthorized frame’) sent for a spoofing attack by any unauthorized third personal without access right to the wireless LAN network WL and thereby protects the wireless LAN network WL from such a spoofing attack. In this embodiment, the unauthorized frame detection process is performed every time a frame is received from either of the terminals STA1 and STA2 after the access point 20 is powered on to activate the frame relaying function.

On the start of the unauthorized frame detection process, every time the communication module 31 of the CPU 30 receives a frame from the terminal STA1 or the terminal STA2 via the receiver 62, the sequence monitor module 33 of the CPU 30 obtains a sequence number from the received frame and stores the obtained sequence number into the RAM 42 (step S110). The sequence number is stored in correlation to the identifier (specifically the MAC address) assigned to each of the terminals STA1 and STA2 as the source terminal of the frame. The sequence numbers represent serial numbers consecutively allocated to frames sent from each terminal. In the IEEE802.11 protocol, the sequence number is data included in sequence control of a MAC frame.

After obtaining the sequence number, the CPU 30 identifies whether the received frame is a deauthentication frame via the wireless LAN network WL (step S120). When the received frame is identified as a non-deauthentication frame (step S120: No), the CPU 30 terminates the current cycle of the unauthorized frame detection process.

When the received frame is identified as a deauthentication frame (step S120: Yes), on the other hand, the sequence judgment module 35 of the CPU 30 determines whether the sequence number included in the received deauthentication frame and sequence numbers obtained and stored in advance in correlation to the source terminal of the deauthentication frame at step S110 satisfy a preset condition (step S130). In this embodiment, two conditions given below are specified as the preset condition. The CPU 30 refers to a record of the sequence numbers obtained and stored in advance in the RAM 42 and, when at least one of the following two conditions is fulfilled, determines satisfaction of the preset condition.

First Condition: The sequence numbers obtained and stored in advance at step S110 include an identical sequence number with the sequence number included in the received deauthentication frame.

Second Condition: Among the sequence numbers obtained and stored in advance at step S110, a sequence number closest to the sequence number included in the received deauthentication frame has a difference exceeding a predetermined range from the sequence number included in the received deauthentication frame.

In this embodiment, the predetermined range in the second condition is a difference in sequence number of or less than 4.

These two conditions are used as the criteria for identifying whether the received deauthentication frame is an authorized frame sent from either of the authorized terminals STA1 and STA2 with the access right to the wireless LAN network WL or an unauthorized frame sent from the unauthorized terminal STA13 by a ‘spoofing’ attack. As mentioned above, the sequence numbers are allocated serially to the individual frames sent from each terminal. The sequence numbers of the successively received frames should be basically the consecutive numerical numbers. Any multiple frames having an identical sequence number are thus not supposed to appear in a practically identical period. The successively received frames may not have the consecutive sequence numbers, due to some variation of the arrival sequence of frames successively sent from an identical terminal or due to some frame loss. Any of such incidents, however, does not cause a significant difference in sequence number. The above two conditions are set for detection of an unauthorized frame by taking advantage of such characteristics of the sequence numbers.

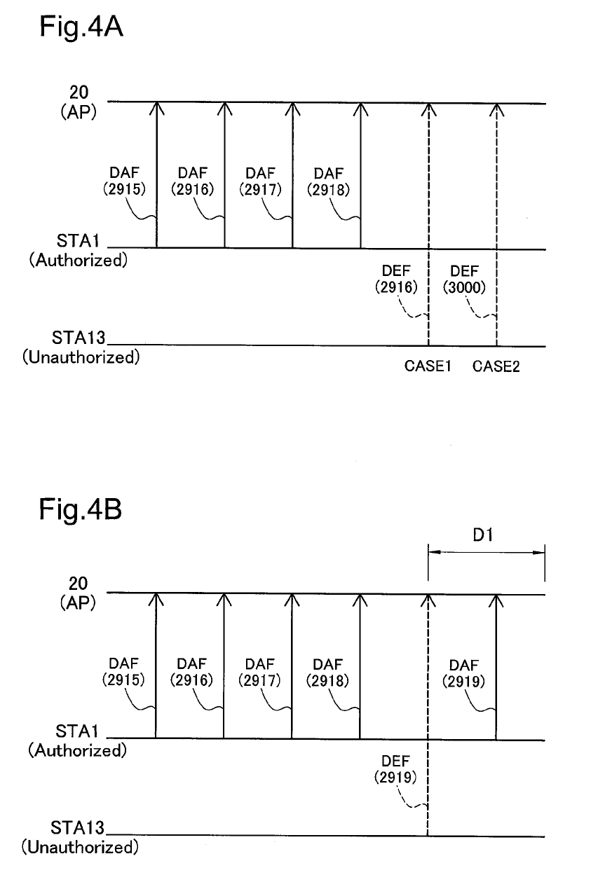

In Case 1 of FIG. 4A, the access point 20 successively receives data frames DAF with consecutive sequence numbers 2915, 2916, 2917, and 2918 from the authorized terminal STA1 and shortly after, receives a deauthentication frame DEF with a sequence number 2916 from the unauthorized terminal STA13 having the same MAC address as the authorized terminal STA1. In this case, one of the data frames DAF received from the terminal STA1 and the deauthentication frame DEF received from the unauthorized terminal STA13 have the same sequence number ‘2916’. The first condition is satisfied in this case. Since the access point 20 has already received the data frames DAF with the consecutive sequence numbers from the terminal STA1, the CPU 30 identifies the received deauthentication frame DEF as an unauthorized frame.

In Case 2 of FIG. 4A, the access point 20 successively receives data frames DAF with consecutive sequence numbers 2915 through 2918 from the authorized terminal STA1 and shortly after, receives a deauthentication frame DEF with a sequence number 3000 from the unauthorized terminal STA13. In this case, among the obtained and stored sequence numbers, the sequence number 2918 is closes to the sequence number 3000 of the received deauthentication frame DEF. A difference between these sequence numbers is 82 (=3000−2918>4). The second condition is satisfied in this case. Such a significant difference in sequence number is not a practical level assignable to a frame loss or to a variation of the arrival sequence of the successively sent frames. Based on satisfaction of the second condition, the CPU 30 identifies the received deauthentication frame DEF as an unauthorized frame.

As clearly understood from the above discussion, the predetermined range in the second condition is used as a reference value or criterion for determining whether a difference between sequence numbers included in successively received frames is a level assignable to a frame loss or to a variation of the arrival sequence of the successively sent frames. The predetermined range in the second condition is accordingly not restricted to the range of or less than 4 but may be set arbitrarily, for example, a range of or less than 16. Setting a relatively wide range to the predetermined range assures detection of only unauthorized frames. The predetermined range in the second condition may alternatively be set to a range of or less than 1 (this means strictly consecutive sequence numbers) without taking into account any possible frame loss or any possible variation of the arrival sequence of the successively set frames. Such setting assures the higher security for detection of unauthorized frames. Even when an authorized deauthentication frame sent from either of the terminals STA1 and STA2 is mistakenly identified as an unauthorized frame, the terminal STA1 or STA2 is only forced to resend the deauthentication frame. This is rather an insignificant matter. The predetermined range in the second condition may otherwise be set arbitrarily in a variable manner by a network administrator or a user. Such setting enables the security level for detection of unauthorized frames to be changed to the network administrator's or the user's desired level according to the working conditions.

When the sequence numbers satisfy the preset condition (step S130: Yes), the CPU 30 identifies the received deauthentication frame as an unauthorized frame (step S180). When the sequence numbers do not satisfy the preset condition (step S130: No), on the other hand, the received deauthentication frame may be an authorized frame or may be an unauthorized frame. The CPU 30 uses another criterion to detect an unauthorized frame as explained below.

The CPU 30 suspends the actual procedure of deauthentication specified by the received deauthentication frame and waits for a preset period D1 (step S140). In this embodiment, the preset period D1 may be specified as a certain period of time (for example, 3 seconds) elapsed since reception of the deauthentication frame. The preset period D1 is, however, not restricted to such setting but may be a period for receiving a predetermined number of frames from the source terminal of the deauthentication frame. In the latter case, it is preferable to set a period for receiving three frames or so. Namely the term ‘period’ in the specification hereof should be interpreted broadly and includes both a period of time and a period for a predetermined operation.

After waiting for the preset period D1, the sequence judgment module 35 of the CPU 30 determines whether any frame having an identical sequence number with the sequence number of the received deauthentication frame is received from the source terminal of the deauthentication frame in the preset period D1 (step S150). In the case of reception of such a frame with the identical sequence number, the CPU 30 identifies the received deauthentication frame as an unauthorized frame (step S180). In the case of no reception of such a frame with the identical sequence number, on the other hand, the CPU 30 identifies the received deauthentication frame as an authorized frame (step S160).

In an illustrated example of FIG. 4B, the access point 20 successively receives data frames DAF with consecutive sequence numbers 2915 through 2918 from the authorized terminal STA1 and shortly after, receives a deauthentication frame DEF with a sequence number 2919 from the unauthorized terminal STA13. The received deauthentication frame DEF appears to be an authorized frame, since the sequence numbers are consecutive. According to the unauthorized frame detection process of this embodiment, however, the CPU 30 suspends the actual procedure of deauthentication specified by the received deauthentication frame DEF and waits for the preset period D1. As shown in FIG. 4B, when receiving a data frame DAF with an identical sequence number 2919 in the preset period D1, the CPU 30 identifies the received deauthentication frame DEF as an unauthorized frame. In response to reception of the data frame DAF with the identical sequence number 2919 in the preset period D1, the CPU 30 may immediately identify the received deauthentication frame DEF as an unauthorized frame without waiting for elapse of the preset period D1.

The unauthorized terminal STA13 is capable of illegally receiving data frames DAF sent from the terminal STA1. The unauthorized terminal STA13 is thus capable of setting a consecutive sequence number in succession to the sequence numbers of the data frames DAF sent from the terminal STA1 and sending a deauthentication frame DEF with the set consecutive sequence number. The unauthorized frame detection process of this embodiment effectively prevents such spoofing of an authorized frame.

When the received deauthentication frame is identified as an authorized frame (step S160), the execution module 32 of the CPU 30 performs the actual procedure of deauthentication with respect to the source terminal of the received deauthentication frame (step S170) and terminates the current cycle of the unauthorized frame detection process. When the received deauthentication frame is identified as an unauthorized frame (step S180), on the other hand, the notification module 37 of the CPU 30 sends an e-mail indicating reception of an unauthorized frame to a mail address registered in advance to notify the network administrator of the access point 20 or the user of reception of an unauthorized frame (step S190) and terminates the current cycle of the unauthorized frame detection process. Upon identification of the received deauthentication frame as an unauthorized frame, the CPU 30 prohibits the execution module 32 from performing the actual procedure of deauthentication.

When a frame is received from either of the terminals STA1 and STA2, the access point 20 of the above configuration obtains a sequence number included in the received frame. When receiving a deauthentication frame, the access point 20 identifies whether the received deauthentication frame is an unauthorized frame, based on the sequence number included in the received deauthentication frame and sequence numbers obtained by the sequence monitor module 33. Upon identification of the received deauthentication frame as an unauthorized frame, the access point 20 prohibits the actual procedure of deauthentication specified by the received deauthentication frame. This arrangement effectively protects the access point 20 from a spoofing attack.

The access point 20 detects an unauthorized frame based on the sequence numbers. This arrangement desirably simplifies the structure of the access point 20. The arrangement of detecting an unauthorized frame based on the sequence numbers in the access point 20 may be adopted for any wireless terminals of various protocols structured to send frames with sequence numbers. This arrangement accordingly has the high versatility, the high resource saving effect, and the high cost reducing effect. The wireless terminals do not require any special structure. Namely the access point 20 of this configuration is applicable to the existing wireless terminals, as well as to a combination of wireless terminals of an old protocol with wireless terminals of a new protocol.

In response to detection of an unauthorized frame, the access point 20 sends an e-mail indicating reception of the unauthorized frame. This arrangement enables the network administrator or the user to be readily notified of reception of the unauthorized frame and to take various effective measures against such a spoofing attack according to the requirements.

### B. Second Embodiment

The structure of the access point 20 and an unauthorized frame detection process in a second embodiment according to the invention are described below.

### B-1. Structure of Access Point 20

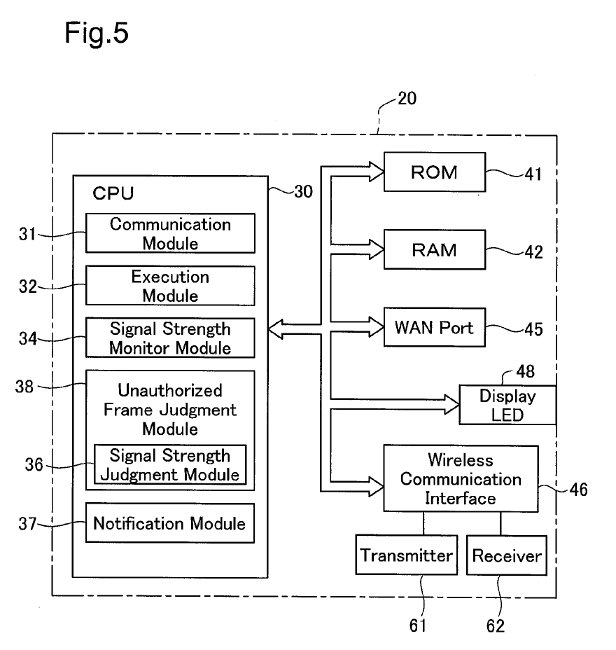

The structure of the access point 20 in the second embodiment is explained with reference to FIG. 5. The hardware configuration of the access point 20 in the second embodiment is identical with that of the access point 20 in the first embodiment. As shown in FIG. 5, the differences from the first embodiment include omission of the functionality of the CPU 30 as the sequence monitor module 33 and the sequence judgment module 35 and the additional functionality of the CPU 30 as a signal strength monitor module 34 and a signal strength judgment module 36. In this embodiment, the unauthorized frame judgment module 38 includes the signal strength judgment module 36 The like constituents of the second embodiment to those of the first embodiment are shown by the like numerals in FIG. 5 to those of FIG. 1. The details of the additional functionality as the signal strength monitor module 34 and the signal strength judgment module 36 will become apparent from the explanation of the unauthorized frame detection process of the second embodiment. The structure of the access point 20 other than the CPU 30 in the second embodiment is identical with that of the first embodiment and is thus not specifically described here.

### B-2. Unauthorized Frame Detection Process

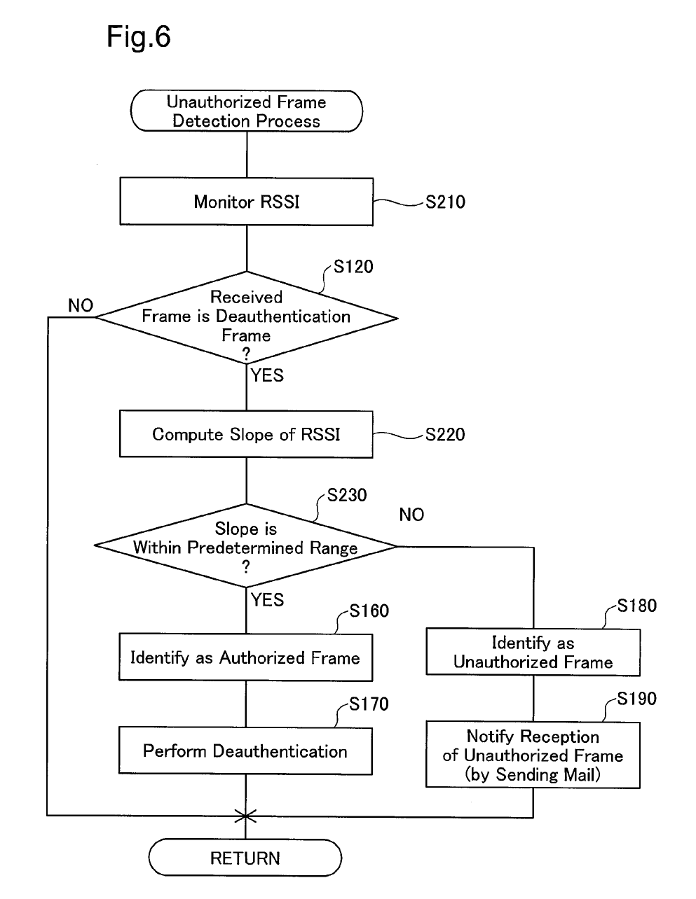

An unauthorized frame detection process performed in the access point 20 of the second embodiment is described with reference to the flowchart of FIG. 6. The same steps in the unauthorized frame detection process of the second embodiment as those in the unauthorized frame detection process of the first embodiment are shown by the same step numbers in FIG. 6 as those of FIG. 3 and are not described in detail here. On the start of the unauthorized frame detection process of the second embodiment, every time a frame is received from either of the terminals STA1 and STA2, the signal strength monitor module 34 of the CPU 30 stores a received signal strength indication (RSSI) of the received frame in correlation to the identifier (specifically the MAC address) of the source terminal into the RAM 42 to monitor the RSSI (step S210).

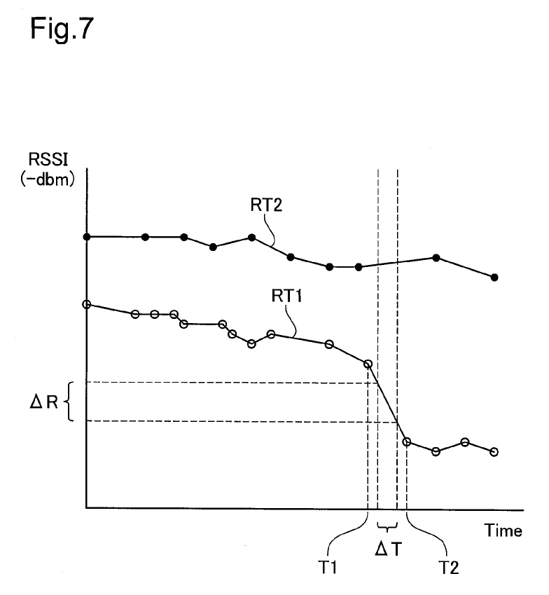

One state of monitoring the received signal strength indication at step S210 is conceptually shown in FIG. 7. A variation in received signal strength indication RT1 of the terminal STA1 and a variation in received signal strength indication RT2 of the terminal STA2 are monitored against the time of frame reception. The respective plots in FIG. 7 represent values of the received signal strength indication at the respective times of frame reception.

In the course of monitoring the received signal strength indication, the CPU 30 identifies whether the received frame is a deauthentication frame (step S120). When the received frame is identified as a non-deauthentication frame (step S120: No), the CPU 30 terminates the current cycle of the unauthorized frame detection process. When the received frame is identified as a deauthentication frame (step S120: Yes), on the other hand, the signal strength judgment module 36 of the CPU 30 computes a slope of the received signal strength indication stored in correlation to the source terminal of the received deauthentication frame at the time of frame reception (step S220). The computation of the slope is explained concretely with reference to FIG. 7. In response to storage of every value of the received signal strength indication at the time of reception of a deauthentication frame, the CPU 30 performs linear interpolation from an adjacent plot of the received signal strength indication and computes a slope of the received signal strength indication or a variation ΔR of the received signal strength indication per unit time ΔT.

After computing the slope of the received signal strength indication, the signal strength judgment module 36 of the CPU 30 determines whether the computed slope is within a predetermined range (step S230). When the computed slope is within the predetermined range (step S230: Yes), the CPU 30 identifies the received deauthentication frame as an authorized frame (step S160). When the computed slope exceeds the predetermined range (step S230: No), on the other hand, the CPU 30 identifies the received deauthentication frame as an unauthorized frame (step S180).

The identification of an unauthorized frame based on the slope of the received signal strength indication is ascribed to the following reason. In the illustrated example of FIG. 1, the authorized terminal STA1 is installed at a position relatively closer to the access point 20, whereas the unauthorized terminal STA13 is installed at a position relatively farther from the access point 20. In this positional relation, the received signal strength indication of a frame sent from the authorized terminal STA1 is generally higher than the received signal strength indication of a frame sent from the unauthorized terminal STA13. In the configuration of this embodiment, the received signal strength indication is monitored in communication between the access point 20 and the terminal STA1. In this case, when the access point 20 receives a frame sent from the unauthorized terminal STA13 spoofing as the authorized terminal STA1, the received signal strength indication is abruptly lowered as shown by the plots at a time T1 and at a subsequent time T2 in FIG. 7. Namely the slope of the received signal strength indication has an abrupt negative increase.

In another example, the authorized terminal STA1 may be installed at a position relatively farther from the access point 20, whereas the unauthorized terminal STA13 may be installed at a position relatively closer to the access point 20. In this case, when the access point 20 receives a frame sent from the unauthorized terminal STA13 spoofing as the authorized terminal STA1, the slope of the received signal strength indication has an abrupt positive increase.

The unauthorized frame detection process of this embodiment utilizes such a phenomenon, which is caused by the difference between the installation position of the authorized terminal STA1 and the installation position of the unauthorized terminal STA13, for detection of an unauthorized frame. The unauthorized terminal STA13 may intentionally vary the received signal strength of an unauthorized frame at the time of unauthorized frame transmission. Even in such events, an unauthorized frame is still detectable as long as there is a significant difference from the received signal strength indication of a frame sent from the authorized terminal STA1.

The user of the terminal STA1 or STA2 may move the installation location of the terminal STA1 or STA2 within the wireless communication area AR1 in the course of communication with the terminal STA1 or STA2. In such cases, the slope of the received signal strength indication may have a relative increase. In order to avoid the confusion from such a slope change caused by the user's movement, the range used as the reference value or criterion of the slope of the received signal strength indication at step S230 may preferably be set to a value that is not generable by the user's movement.

In an access point equipped with multiple radio receiving units, such as an access point adopting a MIMO (multiple input-multiple output) system, the unauthorized frame detection process may independently monitor the received signal strength indication of each of the multiple radio receiving units. In this modified arrangement, the process may comprehensively evaluate the computed slopes of the received signal strength indications of the respective radio receiving units to detect an unauthorized frame with high accuracy.

When the received deauthentication frame is identified as an authorized frame (step S160), the CPU 30 performs the actual procedure of deauthentication with respect to the source terminal of the received deauthentication frame (step S170) and terminates the current cycle of the unauthorized frame detection process. When the received deauthentication frame is identified as an unauthorized frame (step S180), on the other hand, the CPU 30 sends an e-mail indicating reception of an unauthorized frame to a mail address registered in advance to notify the user or the network administrator of reception of an unauthorized frame (step S190) and terminates the current cycle of the unauthorized frame detection process.

The access point 20 of this configuration monitors the received signal strength indication at each time of frame reception from each of the terminals STA1 and STA2. When a slope of the received signal strength indication at the time of reception of a deauthentication frame or a variation of the received signal strength indication within a preset period exceeds a predetermined range, the access point 20 identifies the received deauthentication frame as an unauthorized frame. This arrangement assures detection of an unauthorized deauthentication frame and enables various effective measures to be taken against such a spoofing attack. Upon identification of the received deauthentication frame as an unauthorized frame, the access point 20 prohibits the actual procedure of deauthentication specified by the received deauthentication frame. This arrangement effectively protects the access point 20 from a spoofing attack.

The access point 20 detects an unauthorized frame based on the received signal strength indication. This arrangement desirably simplifies the structure of the access point 20. The arrangement of detecting an unauthorized frame based on the received signal strength indication in the access point 20 may be adopted for any wireless terminals of various protocols. This arrangement accordingly has the high versatility, the high resource saving effect, and the high cost reducing effect. The wireless terminals do not require any special structure. Namely the access point 20 of this configuration is applicable to the existing wireless terminals, as well as to a combination of wireless terminals of an old protocol with wireless terminals of a new protocol.

In response to detection of an unauthorized frame, the access point 20 sends an e-mail indicating reception of the unauthorized frame. This arrangement enables the network administrator or the user to be readily notified of reception of the unauthorized frame and to take various effective measures against such a spoofing attack according to the requirements.

### C. Third Embodiment

The structure of the access point 20 and an unauthorized frame detection process in a third embodiment according to the invention are described below. The unauthorized frame detection process of the third embodiment is the combination of the technique of the first embodiment with the technique of the second embodiment.

### C-1. Structure of Access Point 20

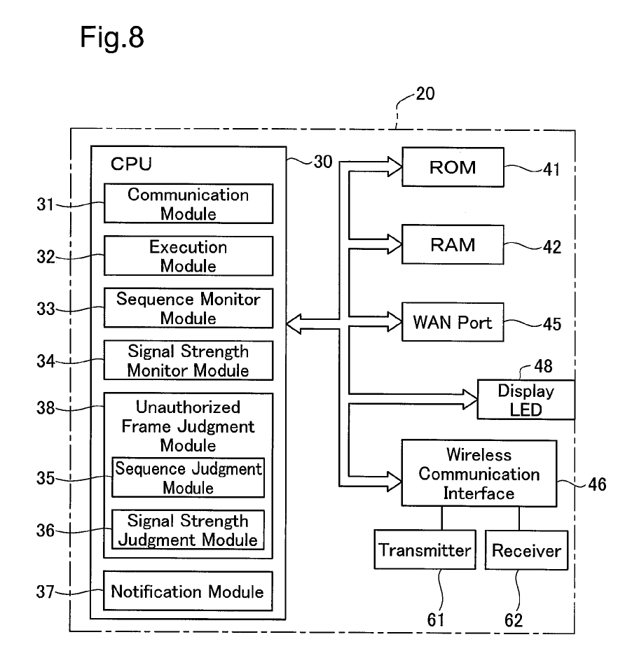

The structure of the access point 20 in the third embodiment is explained with reference to FIG. 8. The hardware configuration of the access point 20 in the third embodiment is identical with that of the access point 20 in the first embodiment. As shown in FIG. 8, the differences from the first embodiment include the additional functionality of the CPU 30 as the signal strength monitor module 34 and the signal strength judgment module 36. In this embodiment, the unauthorized frame judgment module 38 includes the signal strength judgment module 36 Namely the CPU 30 of the third embodiment has the functionality of the CPU 30 of the first embodiment in combination with the functionality of the CPU 30 of the second embodiment. The same constituents in the third embodiment as those in the first embodiment or those in the second embodiment are shown by the same symbols in FIG. 8 as those in FIG. 1 or those in FIG. 5. The details of the functionalities of these constituents have been described previously and are thus not specifically explained here.

### C-2. Unauthorized Frame Detection Process

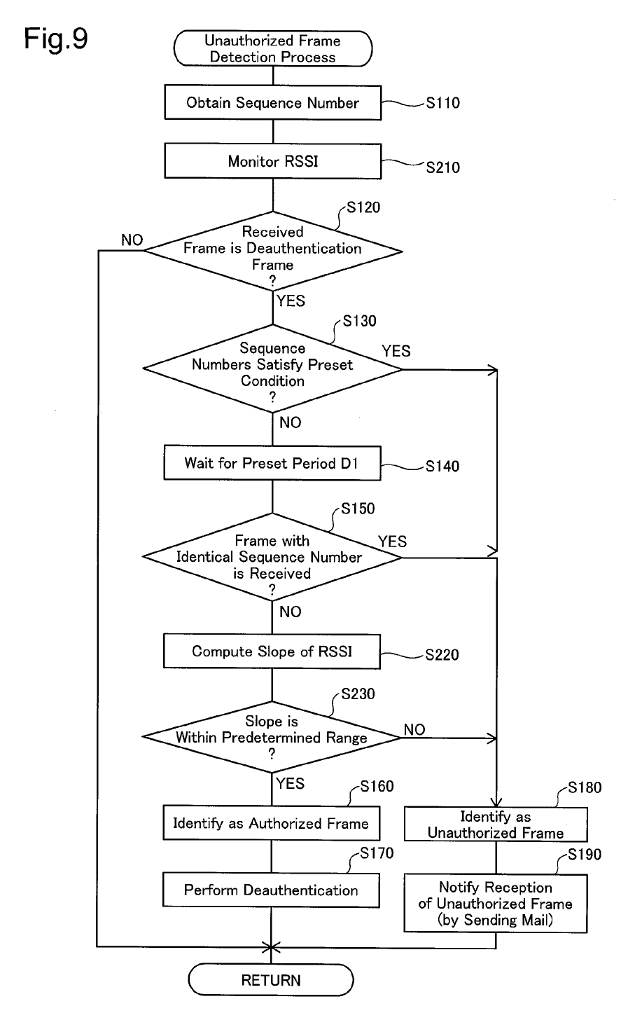

An unauthorized frame detection process performed in the access point 20 of the third embodiment is described with reference to the flowchart of FIG. 9. As mentioned above, the unauthorized frame detection process of the third embodiment is the combination of the unauthorized frame detection process of the first embodiment with the unauthorized frame detection process of the second embodiment. The respective steps of the unauthorized frame detection process in the third embodiment are thus not explained in detail here. The step numbers of the respective steps are identical with the step numbers of the corresponding steps in the first embodiment or in the second embodiment.

On the start of the unauthorized frame detection process of the third embodiment, the CPU 30 obtains a sequence number of each received frame (step S110) and monitors the received signal strength intensity of the received frame (step S210). When the received frame is identified as a deauthentication frame (step S120: Yes), the CPU 30 performs detection of an unauthorized frame by the technique of the first embodiment described above with reference to FIG. 3 (steps S130 through S150).

When the received deauthentication frame is not identified as an unauthorized frame by the technique of the first embodiment based on the results of the decision steps (step S130: No and step S150: No), the CPU 30 subsequently performs detection of an unauthorized frame by the technique of the second embodiment described above with reference to FIG. 6 (steps S220 and S230). When the received deauthentication frame is eventually identified as an unauthorized frame (step S180) based on the result of any of the decision steps (step S130: Yes, step S150: Yes, or step S230: No), the CPU 30 sends an e-mail to notify the user or the network administrator of reception of an unauthorized frame (step S190).

When the received deauthentication frame is eventually identified as an authorized frame (step S160) based on the results of the decision steps (step S130: No, step S150: No, and step S230: Yes), the CPU 30 performs the actual procedure of deauthentication specified by the received deauthentication frame (step S170). In the illustrated example, the unauthorized frame detection process performs the processing of the first embodiment (steps S130 through S150), prior to the processing of the second embodiment (steps S220 and S230). This sequence is, however, not essential but may be reversed.

The access point 20 of this configuration performs the unauthorized frame detection process as the combination of the unauthorized frame detection technique of the first embodiment with the unauthorized frame detection technique of the second embodiment. The access point 20 of the third embodiment accordingly has the effects of both these techniques. Detecting an unauthorized frame by the combination of these two techniques of different viewpoints enhances the accuracy of detection of the unauthorized frame and thereby heightens the security level.

### D. Fourth Embodiment

An unauthorized frame detection process in a fourth embodiment according to the invention is described below. The unauthorized frame detection process of the fourth embodiment detects an unauthorized delete block ACK (acknowledgement) frame or an unauthorized DELBA frame, in place of detection of an unauthorized deauthentication frame in the unauthorized frame detection process of the third embodiment. The delete block ACK frame or DELBA frame is one of the management frames defined in the IEEE802.11 protocol and is used to require cancellation of a block ACK agreement for communication in a block acknowledgement scheme. The block acknowledgement scheme is a known communication system and is thus not described in detail here. In the block acknowledgement scheme, a sender sends a block as a collection of multiple frames, and a receiver returns an ACK (acknowledgement) as a response to reception of the block. The block acknowledgement scheme improves the efficiency of communication.

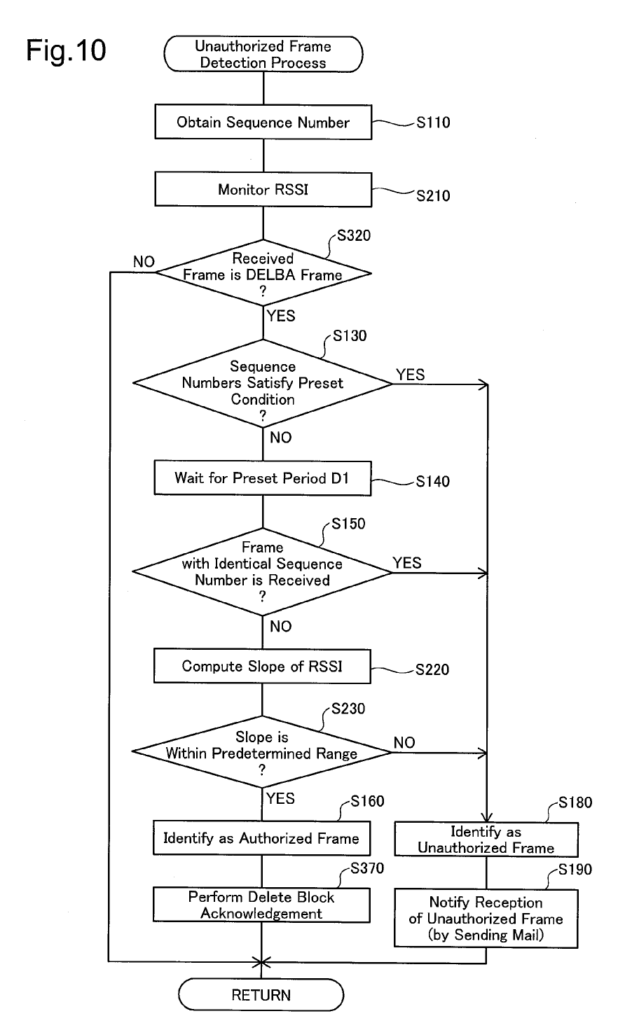

An unauthorized frame detection process performed in the access point 20 of the fourth embodiment is described with reference to the flowchart of FIG. 10. The processing flow of the unauthorized frame detection process of the fourth embodiment is basically similar to the processing flow of the unauthorized frame detection process of the third embodiment shown in FIG. 9. The respective steps of the unauthorized frame detection process in the fourth embodiment are thus not explained in detail here. The step numbers of the respective steps are identical with the step numbers of the corresponding steps in the preceding embodiments.

On the start of the unauthorized frame detection process of the fourth embodiment, the CPU 30 obtains a sequence number of each received frame (step S110) and monitors the received signal strength intensity of the received frame (step S210). When the received frame is identified as a delete block ACK frame or DELBA frame (step S320: Yes), the CPU 30 performs detection of an unauthorized frame by the technique of the first embodiment described above with reference to FIG. 3 (steps S130 through S150).

When the received delete block ACK frame or DELBA frame is not identified as an unauthorized frame by the technique of the first embodiment based on the results of the decision steps (step S130: No and step S150: No), the CPU 30 subsequently performs detection of an unauthorized frame by the technique of the second embodiment described above with reference to FIG. 6 (steps S220 and S230). When the received delete block ACK frame or DELBA frame is eventually identified as an unauthorized frame (step S180) based on the result of any of the decision steps (step S130: Yes, step S150: Yes, or step S230: No), the CPU 30 sends an e-mail to notify the user or the network administrator of reception of an unauthorized frame (step S190).

When the received delete block ACK frame or DELBA frame is eventually identified as an authorized frame (step S160) based on the results of the decision steps (step S130: No, step S150: No, and step S230: Yes), the CPU 30 performs the actual procedure of cancellation of the block ACK agreement specified by the received delete block ACK frame or DELBA frame (step S370).

The unauthorized frame detection process identifies whether the received delete block ACK frame or DELBA frame is an unauthorized frame and, when the received DELBA frame is identified as an unauthorized frame, prohibits the actual procedure of cancellation of the block ACK agreement. In the status of block ACK-based communication established between the access point 20 and the terminals STA1 and STA2, the unauthorized terminal STA13 may spoof as either of the terminals STA1 and STA2 to illegally cancel the block ACK agreement and interfere with communication of the terminal STA1 or STA2. The technique of the fourth embodiment effectively protects the access point 20 from such a spoofing attack. The technique of detecting an unauthorized delete block ACK frame or DELBA frame is similarly applicable to the unauthorized frame detection processes of the first embodiment and the second embodiment described previously.

As clearly understood from the above discussion, the unauthorized management frame to be detected by the access point 20 is not restricted to the deauthentication frame but may be any of various management frames. The access point 20 may be configured to prohibit the actual procedure of a corresponding operation specified by a management frame identified as an unauthorized frame.

### E. Other Aspects

The embodiments discussed above may be modified or changed in various manners. Some possible modifications are given below.

### E-1. Modification 1

In any of the unauthorized frame detection processes of the embodiments discussed above, when a received management frame is identified as an unauthorized frame (step S180), the CPU 30 sends an e-mail indicating reception of an unauthorized frame to notify the user or the network administrator of reception of an unauthorized frame (step S190). The method of notification is, however, not restricted to sending an e-mail. For example, the CPU 30 may log reception of an unauthorized frame as a working record of the access point 20 in the RAM 42 or may light up the display LED 48. In one modified structure of the access point 20 equipped with a display, reception of an unauthorized frame may be shown on the display to notify the user or the network administrator. In another modified structure of the access point 20 equipped with a buzzer or a speaker, reception of an unauthorized frame may be notified as a sound alarm or a voice message to the user or the network administrator.

Notification of reception of an unauthorized management frame to the user or the network administrator is, however, not essential. The CPU 30 may not perform any of such notification operations but may simply prohibit a corresponding operation specified by the received unauthorized management frame. The modified arrangement without the notification still has the effect of protection against a spoofing attack. Prohibition of a corresponding operation specified by a received unauthorized management frame is also not essential. The CPU 30 may not prohibit the corresponding operation specified by the received unauthorized management frame but may simply notify the user or the network administrator of reception of the unauthorized management frame. Such modified arrangements may be adopted when the information transmitted in the wireless LAN network WL is non-classified information. These modified arrangements still inform the user or the network administrator of the presence of a spoofing attack and thereby enable the user or the network administrator to take a necessary measure in the case of transmission of classified information.

### E-2. Modification 2

In any of the unauthorized frame detection processes of the embodiments discussed above, when a received management frame is identified as an unauthorized frame (step S180), the CPU 30 prohibits the actual procedure of a corresponding operation specified by the received unauthorized management frame. One modification may additionally restrict the functionalities of the access point 20. For example, the restriction may prohibit communication for a preset period or may forcibly shut off the power. This modified arrangement enhances the protection level against spoofing attacks.

Among the various constituents and components included in the embodiments of the invention discussed above, those other than the constituents and components included in independent claims are additional and supplementary elements and may be omitted according to the requirements. The embodiments and their modifications and applications discussed above are to be considered in all aspects as illustrative and not restrictive. There may be many other modifications, changes, and alterations without departing from the scope or spirit of the main characteristics of the present invention. The technique of the invention is not restricted to the configuration of the access point discussed above but may be actualized by diversity of other applications, for example, an unauthorized management frame detection method, an unauthorized management frame detection device, computer programs configured to attain the functionalities of the detection device and the functional steps of the detection method, and recording media with such computer programs recorded therein.

What is claimed is:

1. A wireless LAN access point device for transmitting data frames to and receiving data frames from, a wireless terminal over a wireless communication path, comprising:
a communication module for transmitting data frames to and receiving data frames from, the wireless terminal;
an execution module for executing a specific process in response to a predetermined management frame received by the communication module from the wireless terminal;
a sequence monitor module for obtaining a sequence number included in the data frame each time the communication module receives the data frame; and
an unauthorized frame judgment module for identifying the received management frame as an unauthorized frame when a first sequence number obtained by the sequence monitor module and a second sequence number included in the received management frame satisfy a preset condition.

2. The wireless LAN access point device in accordance with claim 1, wherein the execution module prohibits the execution of the process related to the received management frame when the unauthorized frame judgment module judges the received management frame as an unauthorized frame.

3. The wireless LAN access point device in accordance with claim 1, wherein the execution module includes an authentication module for performing an authentication process or a deauthentication process, essential for communication via the wireless LAN access point device; and the predetermined management frame includes a deauthentication frame that requests the deauthentication process.

4. The wireless LAN access point device in accordance with claim 1, wherein at least one of the preset conditions is that there is an overlap between the first sequence number already obtained and the second sequence number.

5. The wireless LAN access point device in accordance with claim 1, wherein at least one of the preset conditions is that the difference between the second sequence number and one of the first sequence numbers already obtained which is closest to the second sequence number, exceeds a preset range.

6. The wireless LAN access point device in accordance with claim 1, wherein at least one of the preset conditions is that the communication module receives another frame which contains the same sequence number as the second sequence number within a preset period after the reception of the management frame.

7. The wireless LAN access point device in accordance with claim 1, further comprising:
a notification module for notifying a user of the wireless LAN access point device of a result of judgment resulted in when the unauthorized frame judgment module identifies the received management frame as an unauthorized frame.

8. The wireless LAN access point device in accordance with claim 7, wherein the notification module transmits mails indicating the result of judgment to a destination having predetermined address, as a means for notification.

9. The wireless LAN access point device in accordance with claim 7, wherein the notification module records the result of judgment as the operation history of the wireless LAN access point device in a memory device provided in the wireless LAN access point device, as a means for notification.

10. A wireless LAN access point device for transmitting data frames to and receiving data frames from, a wireless terminal over a wireless communication path, comprising:
a communication module for transmitting data frames to and receiving data frames from, the wireless terminal;
an execution module for executing a specific process in response to a predetermined management frame received by the communication module from the wireless terminal;
a sequence monitor module for obtaining a sequence number included in the data frame each time the communication module receives the data frame;
a signal strength monitor module for monitoring strength of a signal received when the frame is received, related to the information for identifying the terminal that has sent the frame; and
an unauthorized frame judgment module for judging the received management frame as an unauthorized frame in the case where the first sequence number obtained by the sequence monitor module and the second sequence number included in the received management frame satisfy a preset condition and/or the case where a change during a predetermined period in the signal strength monitored by the signal strength monitor module and related to the information for identifying the terminal that has sent the management frame, exceeds a preset range.

11. The wireless LAN access point device in accordance with claim 10, wherein the execution module prohibits the execution of the process related to the received management frame when the unauthorized frame judgment module judges the received management frame as an unauthorized frame.

12. The wireless LAN access point device in accordance with claim 10, wherein the execution module includes an authentication module for performing an authentication process or a deauthentication process, essential for communication via the wireless LAN access point device; and the predetermined management frame includes a deauthentication frame that requests the deauthentication process.

13. The wireless LAN access point device in accordance with claim 10, wherein at least one of the preset conditions is that there is an overlap between the first sequence number already obtained and the second sequence number.

14. The wireless LAN access point device in accordance with claim 10, wherein at least one of the preset conditions is that the difference between the second sequence number and one of the first sequence numbers already obtained which is closest to the second sequence number, exceeds a preset range.

15. The wireless LAN access point device in accordance with claim 10, wherein at least one of the preset conditions is that the communication module receives another frame which contains the same sequence number as the second sequence number within a preset period after the reception of the management frame.

16. The wireless LAN access point device in accordance with claim 10, further comprising:
a notification module for notifying a user of the wireless LAN access point device of a result of judgment resulted in when the unauthorized frame judgment module identifies the received management frame as an unauthorized frame.

17. The wireless LAN access point device in accordance with claim 16, wherein the notification module transmits mails indicating the result of judgment to a destination having predetermined address, as a means for notification.

18. The wireless LAN access point device in accordance with claim 16, wherein the notification module records the result of judgment as the operation history of the wireless LAN access point device in a memory device provided in the wireless LAN access point device, as a means for notification.

19. An unauthorized management frame detection method for use in a wireless LAN access point device for transmitting data frames to and receiving data frames from, a wireless terminal over a wireless communication path, the method detecting the unauthorized frame by receiving management frames from the wireless terminal and comprising the steps of:
obtaining a sequence number included in the frame each time the frame is received; and
detecting the received management frame as the unauthorized management frame if there is an overlap between the sequence number already obtained and the sequence number included in the received management frame, or if the difference between the sequence number included in the management frame and one of the sequence numbers already obtained which is closest to the sequence number included in the management frame, exceeds a preset range.

20. An unauthorized management frame detection method for use in a wireless LAN access point device for transmitting data frames to and receiving data frames from, a wireless terminal over a wireless communication path, the method detecting the unauthorized frame by receiving management frames from the wireless terminal,
wherein if a frame including the same sequence number as that included in the received management frame is received within a preset period after the management frame has been received, then the received management frame is detected as the unauthorized management frame.
